(19) United States
(12) Patent Application Publication
(10) Pub. No.: US 2013/0176136 A1
(43) Pub. Date: Jul. 11, 2013

(54) DISPLAY PROCESSING SYSTEM, DISPLAY PROCESSING METHOD, AND PROGRAM

(71) Applicant: Haruka Yoshida, Tokyo (JP)

(72) Inventor: Haruka Yoshida, Tokyo (JP)

(73) Assignee: NEC CORPORATION, Tokyo (JP)

(21) Appl. No.: 13/820,276

(22) PCT Filed: Aug. 30, 2011
(86) PCT No.: PCT/JP2011/004837

§ 371 Date: Mar. 1, 2013

(30) Foreign Application Priority Data
Sep. 3, 2010 (JP) 2010-197777

(51) Int. Cl. G08B 5/22

(52) U.S. Cl. CPC G08B 5/22
USPC 340/691.6

(57) ABSTRACT

A display processing system includes a state display unit (104) which presents a usage state of a resource with respect to a reference value for each group based on a statistical value indicating the usage state of the resource, wherein the reference value is that of a value indicating the usage state of the resource of a system providing a service, and is provided for the each group classified in accordance with policy.

### TECHNICAL FIELD

The present invention relates to a display processing system, a display processing method, and a program, and more particularly, to a display processing system, a display processing method, and a program for displaying management information about a system.

### BACKGROUND ART

In recent years, as computers are incorporated into clouds, and at data centers and the like, the enlarged scales and complexity of the information technology (IT) device and services are accelerated. Under such background, how to efficiently manage operation of a system and how to ensure the reliability are an important issue.

Patent document 1 describes an example of a method for identifying a portion causing reduction of the performance in a cluster system including a plurality of resources required to provide services. In the method for identifying a portion causing reduction of the performance in the cluster system of patent document 1, the cluster system includes an information table describing configuration resource and the like for each service group and monitors operation state of a resource. When an performance monitoring item of a resource significantly changes, and the cluster system is in the state showing reduction of the performance, this is used as a trigger, and tendency of the performance monitoring items of all the resources constituting a service group is checked by looking up the information table, and a defective portion (resources) is narrowed down.

As described above, according to the method described in patent document 1, when reduction of the performance of one of the resources in the group providing the same service is found, the cluster system narrows down the defective portion to resources affecting the reduction of the performance in view of the relationship of effect caused by the resources with each other.

### RELATED DOCUMENT

### Patent Document

[Patent document 1] Japanese Unexamined Patent Application Publication No. 2010-73151

### SUMMARY OF THE INVENTION

According to the technique described in patent document explained above, when there are, in a mixed manner, resources of which reference values of monitoring items are different when monitoring whether there are problems with regard to a plurality of resources, there is a problem in that it is difficult to find, at a glance, whether there is a problem in each of the resources with respect to the reference value defined therefor.

This is because, with the technique described in patent document explained above, it is possible to identify a defective portion by narrowing down the affecting resources from among the service group to which the resource with reduced performance belongs to, but the technique does not expect the reference values of the monitoring items which are set differently for each service group. Therefore, when there are resources having different reference values of monitoring items in a mixed manner, it is impossible to present, as means for finding the presence or absence of problem, the usage state of the resources with respect to the reference values in the entire group for each of the groups which are made by grouping many resources, which are to be monitored, based on the reference values of the monitoring items.

The present invention is made in view of the above circumstances, and it is an object of the present invention to provide a display processing system, a display processing method, and a program for improving the efficiency and the reliability of a system management.

According to the present invention, a display processing system includes a state display unit which presents a usage state of a resource with respect to a reference value for each group, based on a statistical value indicating the usage state of the resource, wherein the reference value is that of a value indicating the usage state of the resource of a system providing a service, and is provided for the each group classified in accordance with policy.

According to the present invention, a display processing method includes presenting, by a proceeding apparatus having a display unit, a usage state of a resource with respect to a reference value for each group based on a statistical value indicating the usage state of the resource, wherein the reference value is that of a value indicating the usage state of the resource of a system providing a service, and is provided for the each group classified in accordance with policy.

According to the present invention, a program causes a computer having a display unit to perform a procedure for presenting a usage state of a resource with respect to a reference value for each group based on a statistical value indicating the usage state of the resource, wherein the reference value is that of a value indicating the usage state of the resource of a system providing a service, and is provided for the each group classified in accordance with policy.

It should be noted that, any combination of the above constituent elements and expression of the present invention converted into a method, an apparatus, a system, a recording medium, a computer program, and the like are also effective as an aspect of the present invention.

Various kinds of constituent elements of the present invention may not necessarily exist independently from each other, and may be in the following manner: a plurality of constituent elements may be formed as one member, one constituent element may be formed with a plurality of members, a certain constituent element may be a part of another constituent element, or a part of a certain constituent element may overlap a part of another constituent element.

Further, the method and the computer program of the present invention are described such that a plurality of procedures are described in order, but the order of the description is not intended to limit the order of execution of a plurality of procedures. Accordingly, when the method and the computer program of the present invention are carried out, the order of a plurality of procedures may be changed within the scope not causing any problem in terms of the contents.

Further, the order of a plurality of procedures of the method and the computer program of the present invention is not limited to execution with timing different from each other. For this reason, for example, another procedure may occur during execution of a certain procedure, and execution timing of a certain procedure may partially or entirely overlap execution timing of another procedure.

According to the present invention, it is possible to provide a display processing system, a display processing method, and a program for improving the efficiency and reliability of system management.

### BRIEF DESCRIPTION OF THE DRAWINGS

The aforementioned objects and other objects, features, and advantages will be more apparent from the following preferred exemplary embodiments and the following drawings attached thereto.

FIG. 1 is a functional block diagram illustrating a configuration of a computer of a display processing system according to an exemplary embodiment of the present invention.

FIG. 2 is a functional block diagram illustrating a configuration of a display processing system according to an exemplary embodiment of the present invention.

FIG. 3 is a figure illustrating an example of a display screen of the display processing system according to the exemplary embodiment of the present invention.

FIG. 4 is a flowchart illustrating an example of operation of the display processing system according to the exemplary embodiment of the present invention.

FIG. 5 is a functional block diagram illustrating a configuration of a display processing system according to an exemplary embodiment of the present invention.

FIG. 6 is a flowchart illustrating an example of operation of the display processing system according to the exemplary embodiment of the present invention.

FIG. 7 is a functional block diagram illustrating a configuration of a display processing system according to an exemplary embodiment of the present invention.

FIG. 8 is a figure illustrating an example of a display screen of the display processing system according to the exemplary embodiment of the present invention.

FIG. 9 is a figure illustrating an example of a display screen of the display processing system according to the exemplary embodiment of the present invention.

FIG. 10 is a figure illustrating an example of a display screen of the display processing system according to the exemplary embodiment of the present invention.

FIG. 11 is a flowchart illustrating an example of operation of the display processing system according to the exemplary embodiment of the present invention.

FIG. 12 is a figure illustrating an example of a display screen of the display processing system according to the exemplary embodiment of the present invention.

FIG. 13 is a figure illustrating an example of a display screen of the display processing system according to the exemplary embodiment of the present invention.

FIG. 14 is a figure illustrating an example of a display screen of the display processing system according to the exemplary embodiment of the present invention.

### DESCRIPTION OF EXEMPLARY EMBODIMENTS

Exemplary embodiments of the present invention will be hereinafter explained with reference to drawings. In all the drawings, the similar reference numerals are attached to the similar constituent elements, and the description thereof will not be repeated as necessary.

### First Exemplary Embodiment

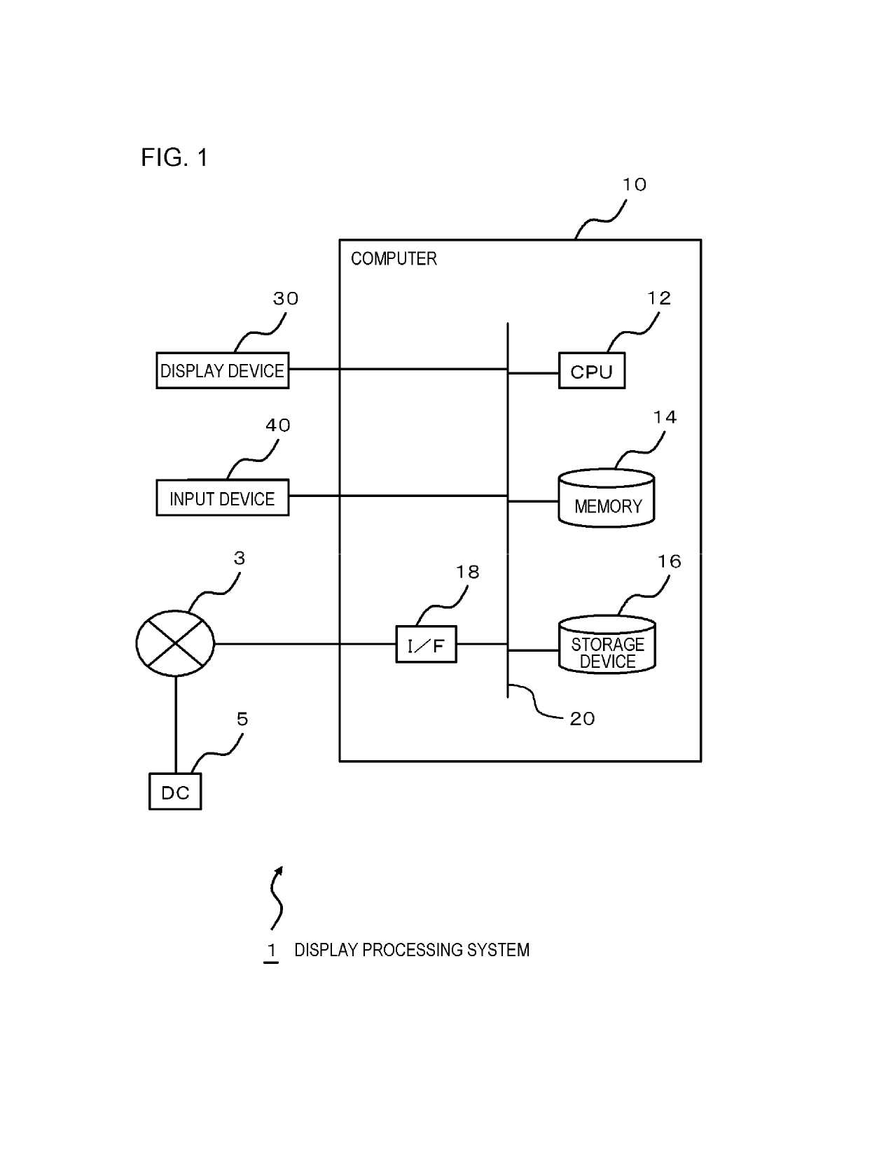

FIG. 1 is a functional block diagram illustrating a configuration of a display processing system 1 according to the exemplary embodiment of the present invention.

For example, the display processing system 1 according to the exemplary embodiment of the present invention presents, to users, information indicating operation management state of many IT devices and services of a data center (DC) 5 connected through a network 3. In the present exemplary embodiment, the user is, for example, an administrator who manages the system of the data center 5, and the like. Hereinafter, the user will be referred to as “administrator” in order to distinguish it from service users. Further, the administrators include not only the administrator who monitors the system of the data center 5 at all times but also managers and executives who sometimes come to the site and the like to check the state of the system. In particular, the display processing system 1 of the present exemplary embodiment is preferably configured such that the usage states of resources and the like can be determined at a glance when the managers, the executives, and the like of the data center 5 see the screen.

The display processing system 1 includes, for example, a computer 10 including a central processing unit (CPU) 12, a memory 14, a storage device 16 such as a hard disk, and a communication device (interface (I/F) 18 in the drawing). The CPU 12 is connected to each element of the computer 10 through a bus 20, and the CPU 12 as well as each element controls the overall computer 10. The computer 10 of the display processing system 1 can be achieved with a server computer, a personal computer, or a device corresponding thereto which is connected to an input device 40 such as a keyboard or a mouse, a display device 30 such as a display, and an output device such as a printer (not shown). Then, the CPU 12 loads a program stored in the storage device 16 to the memory 14 and executes the program, thus achieving each function of each unit explained below.

In each drawing, a configuration about a portion not related to the essential of the present invention is omitted, and not shown in the drawings.

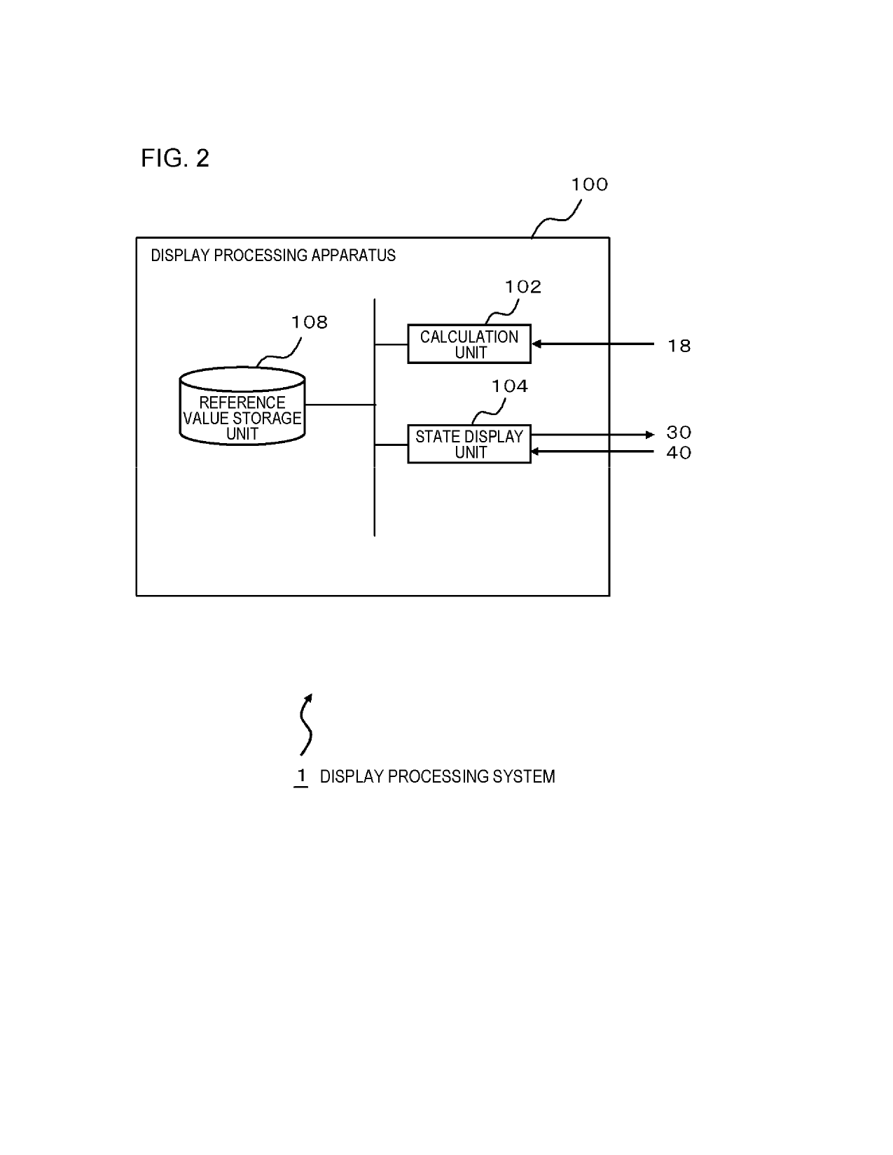

FIG. 2 is a functional block diagram illustrating a configuration of a display processing apparatus 100 achieved by a computer 10 of the display processing system 1 according to the exemplary embodiment of the present invention.

As illustrated in FIG. 2, the display processing system 1 according to the present exemplary embodiment includes a state presentation unit (state display unit 104) providing a reference value of a value indicating the usage state of a resource of the system providing a service, for each group classified in accordance with policy, and presenting the usage state of the resource with respect to the reference value for each group based on statistical value.

Each constituent element of the display processing apparatus 100 is achieved with a combination of software and hardware of the computer 10 (FIG. 1) explained above having the CPU 12, the memory 14, the program achieving constituent elements of this drawing loaded to the memory 14, the storage device 16 such as a hard disk storing the program, and a network connection interface 18. Further, a person skilled in the art could understand that various modifications exist for the achieving method and the apparatus. Each drawing explained below is illustrated as blocks in units of functions, not the configuration in units of hardware.

The computer program according to the present exemplary embodiment is described to cause the computer 10 (FIG. 1) for achieving the display processing apparatus 100 to perform a procedure for presenting the usage state of a resource with respect to a reference value, for each group, based on the statistical value indicating the usage state of the resource.

The computer program according to the present exemplary embodiment may be recorded in a computer-readable recording medium. The recording medium is not particularly limited, and various forms of recording media may be considered. The program may loaded from the recording medium to the memory of the computer, or may be downloaded through a network to the computer, and loaded to the memory.

More specifically, the display processing apparatus 100 includes a calculation unit 102, a state display unit 104, and a reference value storage unit 108.

In the present exemplary embodiment, the policy may be defined by an operation rule defined in advance between a service user and a service provider in accordance with a system, for example, SLA (Service Level Agreement). The SLA is a system with which the service provider offers, to the service user, guarantee of the quality of service provided to the service user. This SLA has different reference values and the like to performance (asset quality), and utilization ratio and traffic of a resource, in IT devices providing a service included in the operation rule in accordance with the rank.

The value indicating the usage state of the resource includes a CPU utilization and the like. This value is independently defined in accordance with the type and the degree of importance of a service provided to the service user or in accordance with a request of the service user.

In the present exemplary embodiment, different reference values are provided for the CPU utilization in accordance with four ranks, that are, “S”, “A”, “B”, and “C” ranks. The service provider needs to provide the service user with the service so as to satisfy the reference value corresponding to the rank according to the contract. Therefore, the service provider monitors the usage state of the resource in each rank, checks whether the CPU utilization satisfies the reference value, and takes measures to use the resource without waste. Further, if there is a problem of overload, the service provider needs to take measures to solve the problem.

For example, in the “S” rank, the service provider offers guarantee of high quality to the user. In the “S” rank, a server (not shown) with higher performance may be allocated specifically to the service. Then, by setting the reference value of the CPU utilization at about 40% even at the peak time, the service provider may offer, to the user, guarantee of operating the service while the load of the CPU is not tight.

For example, in the “C” rank, the cost is regarded as more important than the quality. In the “C” rank, the service provider provides the service to the user while making the best use of a virtualized server (not shown). Then, the reference value of the CPU utilization is set at 80% or higher at the peak time and 60 to 70% in average, whereby the service provider may offer, to the user, guarantee of operation where the usage state of the resource is in the best-effort state.

In the present exemplary embodiment, different values of CPU utilization (%) are provided for four groups corresponding to four ranks, respectively. For example, the reference value of the CPU utilization is 40% for the group of the “S” rank and 70% for the group of the “C” rank, which are defined in advance in accordance with the policy. The reference value of the CPU utilization corresponding to each group is stored to the reference value storage unit 108 explained later.

Information about group classification of each resource or allocation information of resources of each group is managed on a management server of the data center 5. In the present exemplary embodiment, one resource (for example, a server) in the data center 5 is used by only the service users who belong to the same group. In the display processing system 1 according to the present exemplary embodiment, when the display processing apparatus 100 collects information indicating the usage state of the resources of a plurality of computers in the data center 5 from each server (not shown) or the management server (not shown), the display processing apparatus 100 may collect the information based on information about the group associated with the resource.

The calculation unit 102 calculates, for each group, the statistical value indicating the usage state of the resource with a predetermined cycle. The calculated statistical value may be accumulated in the memory 14 (FIG. 1) of the display processing apparatus 100, and may be used later.

When the calculation unit 102 calculates the statistical value, information indicating the usage state of the resource of the computer in the data center 5, for example, the CPU utilization may be collected, with a regular interval or as necessary, through the interface 18 from each server or management server on the network 3. As described above, the information about the group of the resource is associated with the information indicating the usage state of the resource, and therefore, the collected information indicating the usage state of the resource may be counted for each group.

The information indicating the usage state of the resource that is associated with the group collected from the server may be stored to the memory 14 with a regular interval or as necessary. Then, the calculation unit 102 of the display processing apparatus 100 may use the value stored in the memory 14. Alternatively, the display processing apparatus 100 may also obtain the information by reading the information from a recording medium recording the information indicating the usage state of the resource of the target computer collected from each server or management server, which is recorded in advance for a certain period of time. In this manner, the information indicating the usage state of the resource associated with the group may be obtained according to various methods with various timing.

The statistical value indicating the usage state of the resource calculated by the calculation unit 102 is obtained by relative statistics processing corresponding to the reference value. For example, the statistical value may include an average value, a maximum value, a minimum value, or a dispersion width (for example, 50%, 80%), and the like for a predetermined period. The display processing apparatus 100 may display these statistical values. The administrator may select and specify which statistical value is to be displayed, using a menu list and the like, whereby the display may be changed. Alternatively, the display processing apparatus 100 may present a plurality of statistical values on a single screen.

In the present exemplary embodiment, a predetermined period in which statistics processing of the statistical value indicating the usage state of the resource is performed may be a period specified by an administrator in advance and by changing the period as necessary, such as one week, one month, three months, six months, one year, multiple years, or any given specified period. The predetermined period and the like of the statistics processing and the information indicating the usage state of the resource to be monitored may be selected in advance or selected as necessary by the administrator on a setting screen (not shown).

In the present exemplary embodiment, the calculation unit 102 may not be necessary, and the statistical value already calculated by another computer connected through the network 3 with the display processing apparatus 100 may be collected and used.

The state display unit 104 presents the usage state of the resource with respect to the reference value for each group, based on the calculated statistical value.

The reference value storage unit 108 stores the reference value of the value indicating the usage state of the resource of the system providing the service, provided for each group classified according to the policy. The reference value stored in the reference value storage unit 108 may be input, checked, and changed by a system administrator with a setting screen (not shown).

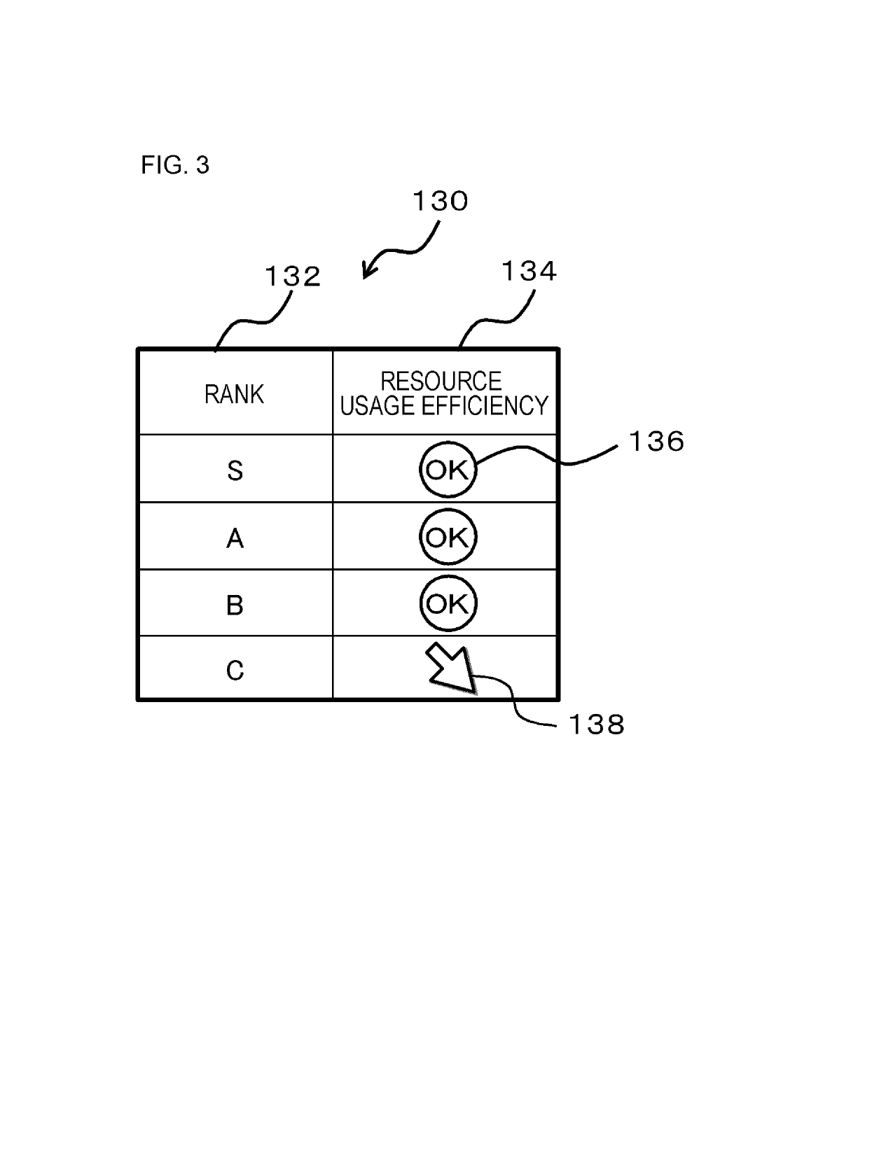

FIG. 3 is a figure illustrating an example of a screen 130 of the display processing system 1 according to the present exemplary embodiment.

As illustrated in FIG. 3, the screen 130 includes a list table indicating the usage state of the resource with respect to the reference value for each group (in the figure, “rank”). The list table of the screen 130 includes a rank field 132 displaying a group name and a resource usage efficiency field 134 displaying the information indicating the usage state of the resource.

In FIG. 3, the screen 130 displays an OK icon 136 indicating that the usage state of the resource is within the tolerance range of the reference value and an arrow icon 138 indicating that a problem occurs in the usage state of the resource. Each icon is to present the tendency of the change of the resource usage state to the administrator. As illustrated in FIG. 3, an arrow icon 138 of which arrow is pointing downward may present, to the administrator, that the usage state of the resource is less than the reference value shows a reduction tendency with respect to the reference value. On the other hand, when the arrow of the arrow icon is upward (not shown), this may present, to the administrator, that the usage state of the resource is more than the reference value or shows an increasing tendency with respect to the reference value. Alternatively, it may be possible to present, to the administrator, the tendency of the change of the resource usage state, using another icon, for example, a character icon such as “NG”, indicating that the usage state of the resource is out of the tolerance range of the reference value on the screen 130.

Operation of the display processing system 1 according to the present exemplary embodiment thus configured as described above will be explained below.

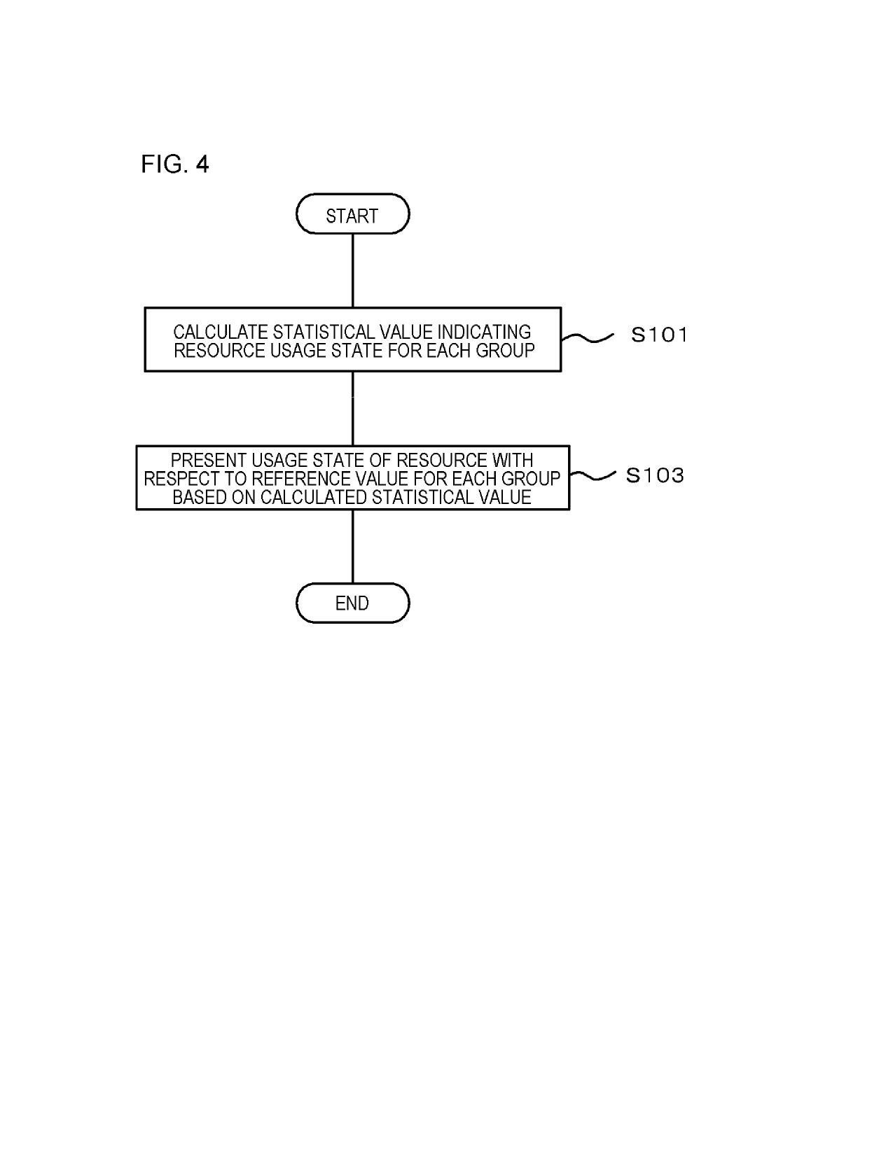

FIG. 4 is a flowchart illustrating an example of operation of the display processing system 1 according to the present exemplary embodiment. Hereinafter, explanation will be made with reference to FIGS. 1 to 4.

The display processing method according to the present exemplary embodiment includes presenting, by the display processing apparatus 100 having the display device 30, the usage state of the resource with respect to a reference value, for each group, based on the statistical value indicating the usage state of the resource (step S103).

More specifically, first, in the display processing system 1 according to the present exemplary embodiment, the calculation unit 102 of the display processing apparatus 100 (FIG. 2) calculates the statistical value indicating the resource usage state for each group (step S101). Then, the state display unit 104 (FIG. 2) of the display processing apparatus 100 looks up the reference value storage unit 108 (FIG. 2) of the display processing apparatus 100, and displays, based on the calculated statistical value, the screen 130 (FIG. 3) presenting the resource usage state with respect to the reference value for each group, on the display device 30 (FIG. 1) (step S103).

As described above, the resource usage state is displayed for each group on the screen 130 of FIG. 3, and the administrator can understand the resource usage state at a glance.

The processing of this flowchart is started with a predetermined cycle, and is repeatedly executed. The processing for calculating the statistical value in step S101 and the processing for updating the display of the resource usage state in step S103 may be not necessarily executed with the same cycle. Step S101 is repeatedly executed at all times, and step S103 may be executed only when a request for displaying the screen 130 by the administrator is received.

As explained above, according to the display processing system 1 according to the present exemplary embodiment, when there are resources of which reference value of the monitoring item is different, it is possible to find, at a glance, the state of the usage state of the resource with respect to the reference value for each group. Therefore, when a problem is expected, measures can be quickly taken to solve the problem, and as a result, the efficiency and reliability of the system management are improved.

For example, when the CPU utilization is higher than the reference value of the group, the load of the server of the group is considered to be too high. Therefore, the administrator receives the result, and can take measures to satisfy the reference of the group, for example, changing and increasing the allocation of the resource of the group, additionally installing servers, and replacing the servers with those with higher performance. When the load of the server is high, this may cause system failure, and measures can be taken quickly by presenting whether there is a problem in the usage state of the resource as described above, and therefore, the reliability of the system is improved.

When the CPU utilization is less than the reference value of the group, it is considered that the resource of the group is wasted. Therefore, the administrator receives the result, and reduces the power consumption by changing and reducing the allocation of the resource of the group and stopping the use of a non-operating server by turning off the server, or can take measures to satisfy the reference of the group, for example, making a plan to further increase the contracts of that group.

### Second Exemplary Embodiment

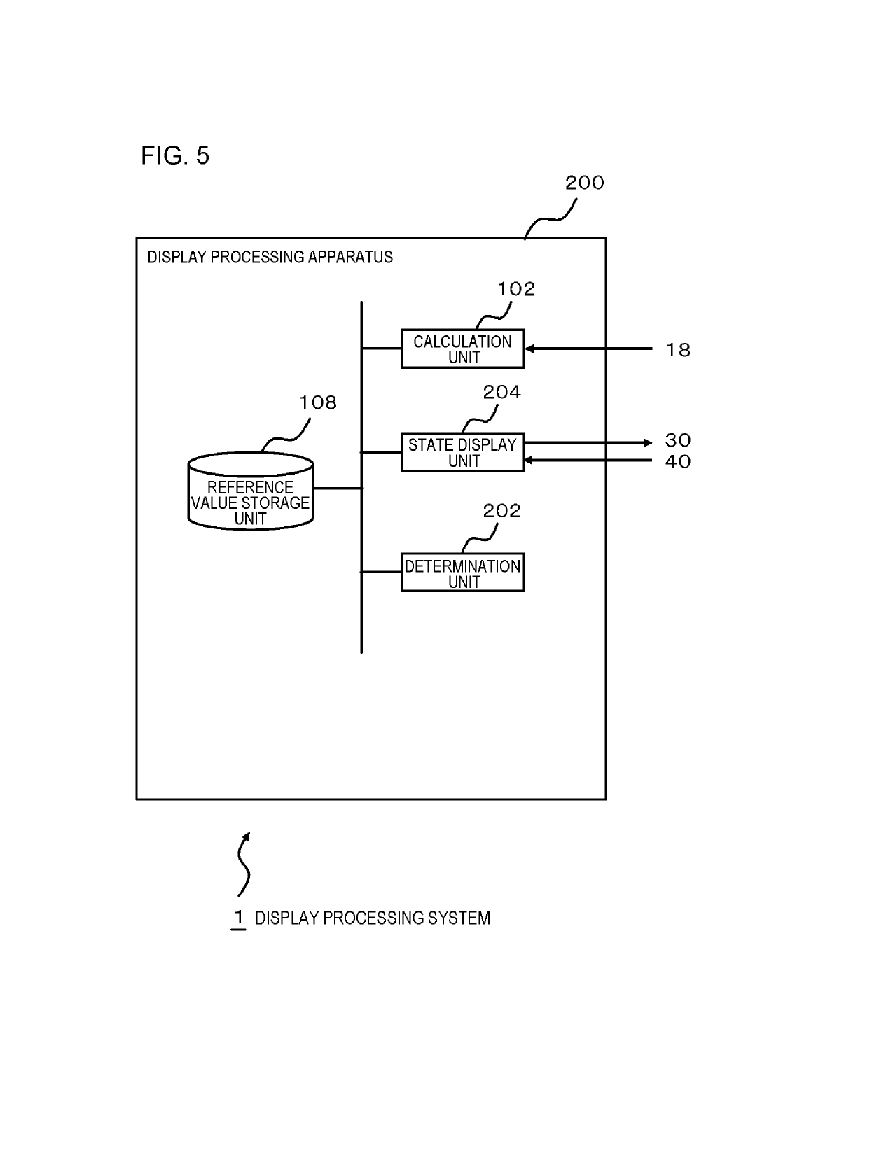

FIG. 5 is a functional block diagram illustrating a configuration of a display processing apparatus 200 achieved by a computer of a display processing system 1 according to the exemplary embodiment of the present invention. The display processing system 1 according to the present exemplary embodiment is different from the above exemplary embodiment in that the display processing system 1 according to the present exemplary embodiment determines and presents whether there is a problem in the usage state of the resource.

The display processing apparatus 200 according to the present exemplary embodiment includes not only the calculation unit 102 and the reference value storage unit 108 of the display processing apparatus 100 of the above exemplary embodiment of FIG. 2, but also a determination unit 202 for determining whether there is a problem in the usage state of the resource based on the statistical value and the reference value for each group, and a state display unit 204 for presenting a determination result provided by the determination unit 202.

More specifically, the display processing system 1 according to the present exemplary embodiment includes not only the calculation unit 102 and the reference value storage unit 108 configuring the display processing apparatus 100 of the above exemplary embodiment of FIG. 2, but also a determination unit 202 and a state display unit 204.

The determination unit 202 determines whether the statistical value is within the tolerance range of the reference value, based on the statistical value calculated by the calculation unit 102 and the reference value stored in the reference value storage unit 108. Then, when the statistical value is within the tolerance range, the determination unit 202 determines that there is no problem in the usage state of the resource, and when the statistical value is out of the tolerance range, the determination unit 202 determines that there is a problem in the usage state of the resource. Then, the determination unit 202 notifies the determination result indicating whether there is a problem or not to the state display unit 204.

The determination result made by the determination unit 202 is not limited to whether there is a problem or not. For example, the determination unit 202 may determine the degree of problem in accordance with the relationship between the statistical value and the reference value, and may classify the result into several levels and may notify it as the determination result to the state display unit 204. The determination unit 202 may look up history of the statistical value in the past, and in view of the tendency of the change of the statistical value, it may be notified as the determination result to the state display unit 204.

The state display unit 204 receives the determination result from the determination unit 202, and displays information and images indicating the determination result on the screen 130 as illustrated in FIG. 3. The state display unit 204 presents, for example, an image indicating that there is no problem in the resource usage state such as an OK icon 136 in the resource usage efficiency field 134 of the group receiving the notification indicating that there is no problem in the usage state of the resource from the determination unit 202, and presents an image (not shown) indicating that there is a problem in the resource usage state.

When the degree of problem of the resource usage state is shown, this may be displayed by changing the color of an image such as an icon and using an image having different mark, symbol, and pattern, in accordance with the degree of problem. When whether there the resource usage state or not is indicated, it is preferable to display an image with which whether there is a problem or not can be recognized immediately in a visual manner. For example, when there is a problem, icons in red and yellow are preferably displayed, and when there is no problem, icons in blue and green are preferably displayed. As described above, when there is a problem, an icon in which characters such as “NG” are written may be used, and when there is no problem, an icon in which characters such as “OK” are written may be used.

Operation of the display processing system 1 according to the present exemplary embodiment configured as described above will be explained below.

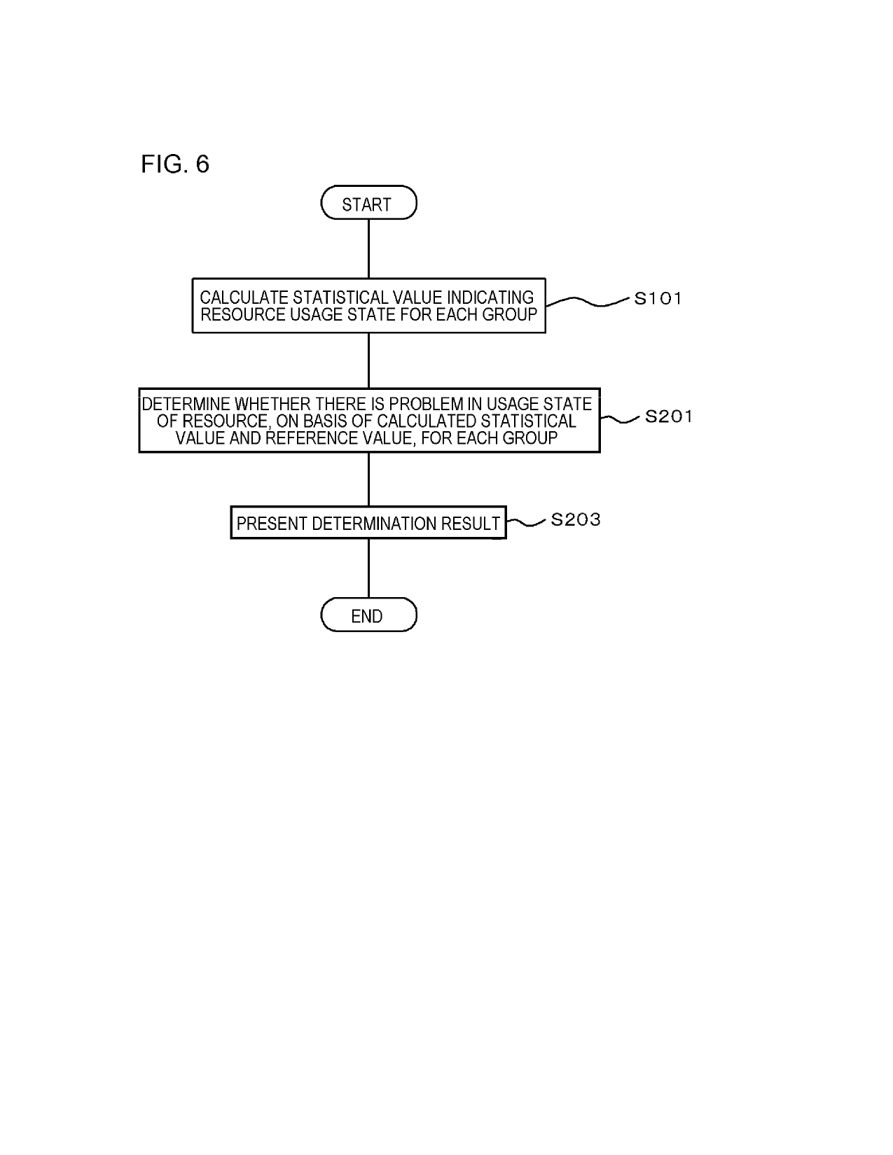

FIG. 6 is a flowchart illustrating an example of operation of the display processing system 1 according to the present exemplary embodiment. Hereinafter, explanation will be made with reference to FIGS. 5, 6, and 3.

First, in the display processing system 1 according to the present exemplary embodiment, the calculation unit 102 (FIG. 5) of the display processing apparatus 200 calculates the statistical value indicating the resource usage state for each group (step S101). Then, the determination unit 202 (FIG. 5) of the display processing apparatus 200 looks up the reference value storage unit 108 (FIG. 2) of the display processing apparatus 100, and determines whether there is a problem in the resource usage state or not based on the calculated statistical value and the reference value for each group (step S201).

Then, the state display unit 204 (FIG. 5) of the display processing apparatus 200 receives the determination result from the determination unit 202 of the display processing apparatus 200, and displays, on the display device 30 (FIG. 1), a screen 130 (FIG. 3) indicating whether there is a problem in the resource usage state with respect to the reference value for each group (step S203).

As described above, whether there is a problem in the resource usage state is displayed for each group on the screen 130 of FIG. 3, and the administrator can find, at a glance, whether there is a problem in the resource usage state or not.

Like the above exemplary embodiment, the processing of this flowchart is started with a predetermined cycle, and is repeatedly executed. The processing for calculating the statistical value in step S101 and the processing for updating the display of the resource usage state in step S201 may be not necessarily executed with the same cycle. Preferably, step S101 is repeatedly executed at all times, and step S201 may be executed only when a request for displaying the screen 130 by the administrator is received.

As explained above, according to the display processing system 1 according to the present exemplary embodiment, the effects similar to those of the above exemplary embodiment are achieved, and it is possible to find, at a glance, whether there is a problem in the usage state of the resource with respect to the reference value for each group. Therefore, when a problem is expected, measures can be quickly taken to solve the problem, and as a result, the efficiency and reliability of the system management are improved.

### Third Exemplary Embodiment

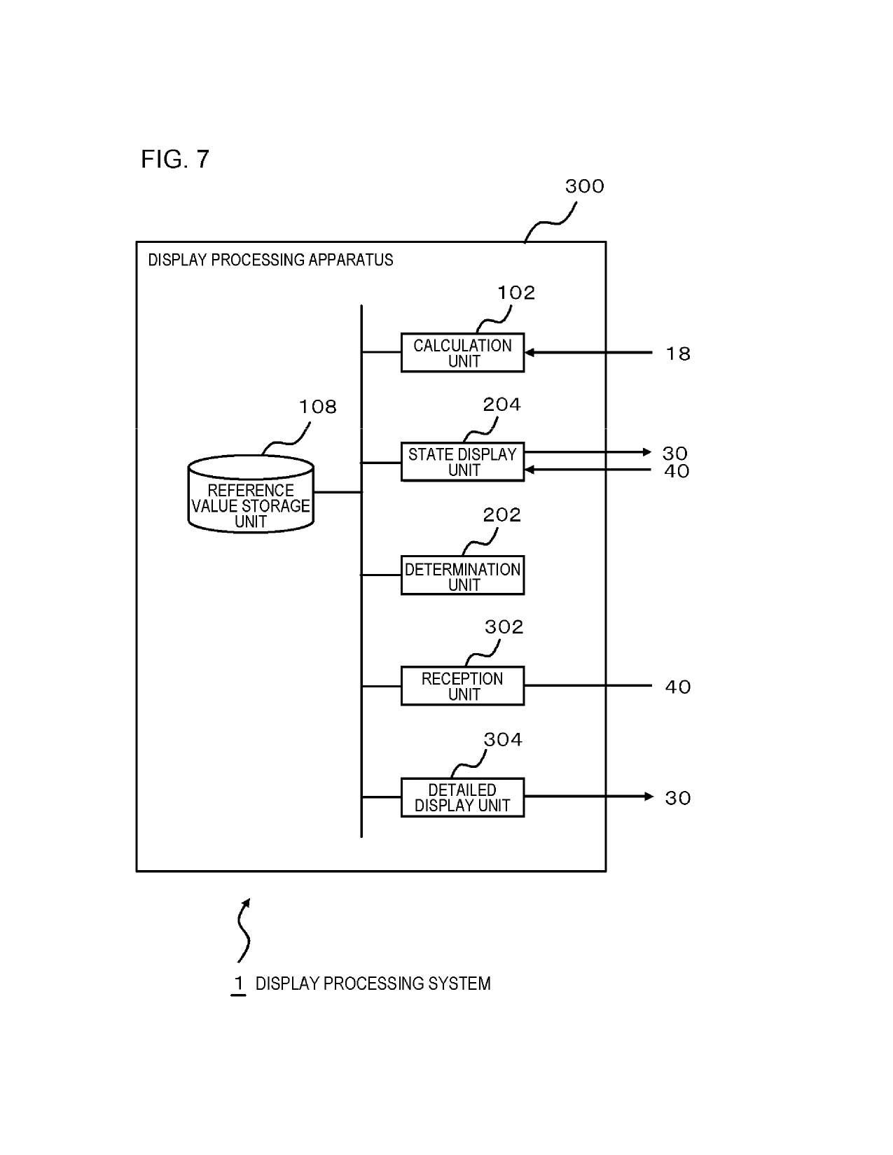

FIG. 7 is a functional block diagram illustrating a configuration of a display processing apparatus 300 achieved by a computer of a display processing system 1 according to the exemplary embodiment of the present invention. The display processing system 1 according to the present exemplary embodiment is different from the above exemplary embodiment in that the display processing system 1 according to the present exemplary embodiment schematically presents the usage state of the resource for each group in an easy-to-understand manner.

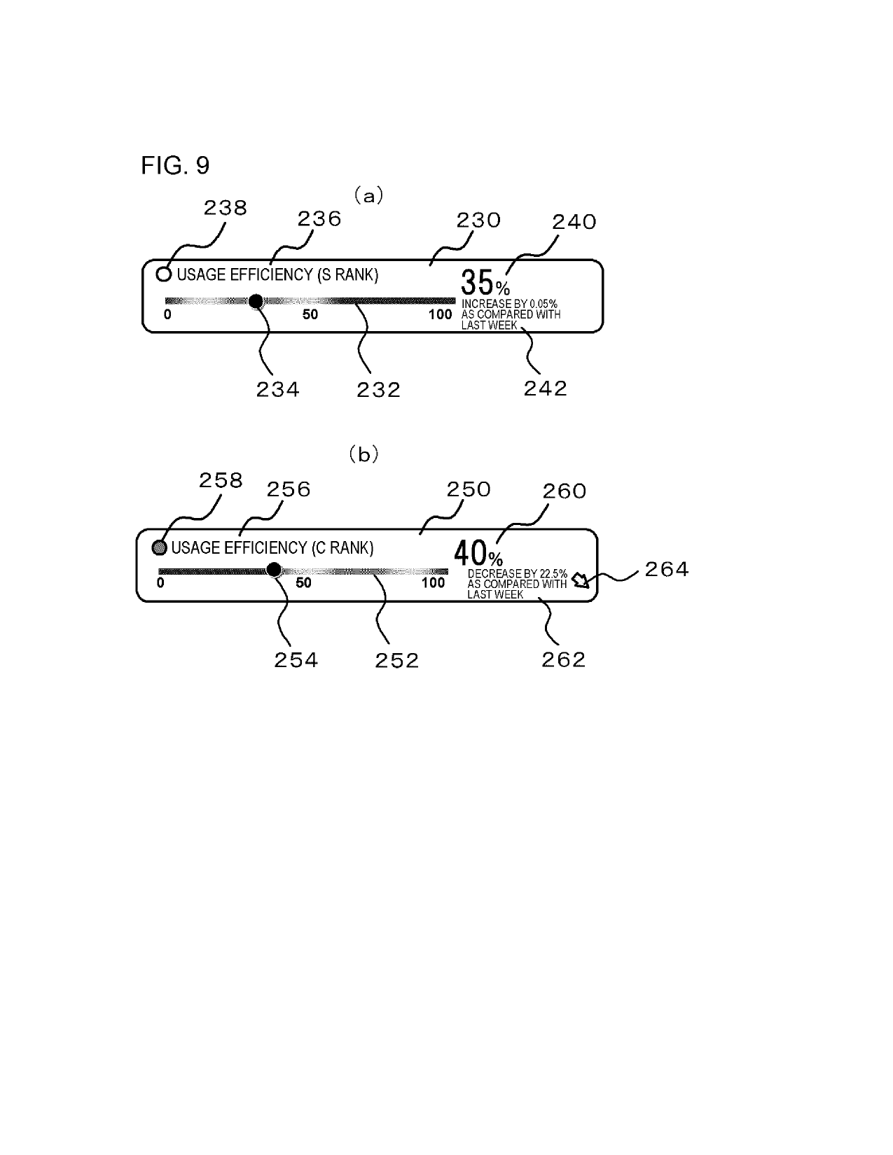

In the display processing apparatus 300 according to the present exemplary embodiment, a state display unit 204 displays a statistical value on an indication scale (indicator 232 of FIG. 9) indicating the index based on the reference value, and presents the usage state of the resource.

More specifically, the display processing system 1 according to the present exemplary embodiment further includes not only the configuration of the display processing apparatus 200 of the above exemplary embodiment of FIG. 5 but also a reception unit 302 and a detailed display unit 304. The display processing apparatus 300 according to the present exemplary embodiment may further includes not only the configuration of the display processing apparatus 100 of the above exemplary embodiment of FIG. 2 but also a reception unit 302 and a detailed display unit 304.

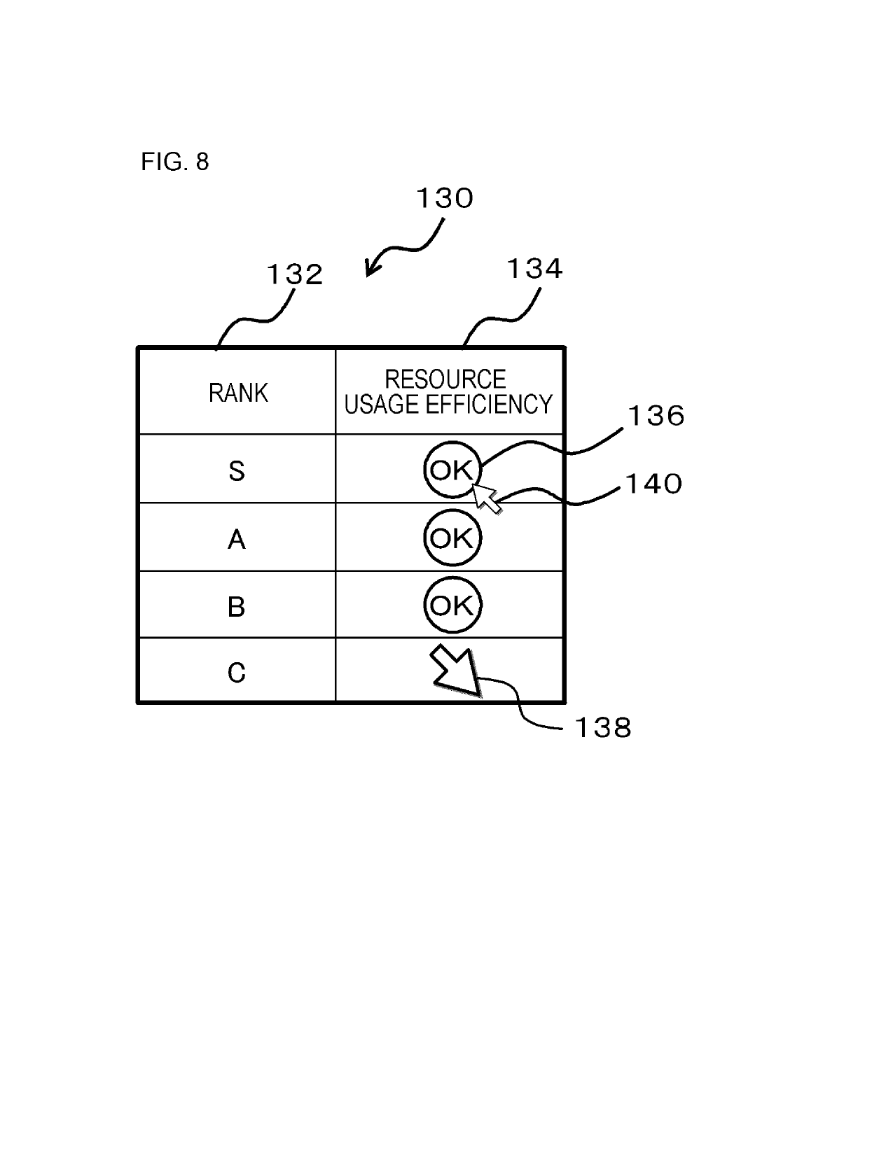

As operation for seeing detailed information of the resource usage state for each group, the administrator performs as follows. As illustrated in FIG. 8, on the screen 130, when the administrator uses an input device 40 to move a mouse pointer 140 to an icon of a resource usage efficiency field 134 to select it, detailed information about the group of the selected icon is displayed on the screen.

The reception unit 302 receives the group selected by the administrator to display the detailed information. The present exemplary embodiment is configured to see detailed information of each group, but the present exemplary embodiment is not limited thereto. An operation button may be provided to receive a command for opening a screen of detailed information, and it may be received as a command for opening a screen including detailed information about all the groups. For the detailed information for each group, a plurality of groups may be selected, and a plurality of screens may be opened. Alternatively, detailed information about all the groups may be displayed together with the screen 130 of FIG. 3. In the present exemplary embodiment, an icon is used to select a group, but the present exemplary embodiment is not limited thereto, and various kinds of graphical user interfaces (GUIs) may be used.

The detailed display unit 304 displays, on the display device 30, detailed information about the resource usage state of the group received by the reception unit 302. FIG. 9(a) is an example of an image 230 representing a resource usage state in the “S” rank. FIG. 9(b) is an example of an image 250 representing a resource usage state in the “C” rank.

As illustrated in FIG. 9(a), the image 230 includes, for example, an indicator 232, a state icon 234, a group display section 236, a problem display section 238, a numerical value display section 240, and an increase or decrease display section 242.

The indicator 232 represents an index based on the reference value of the resource usage state in the “S” rank. The state icon 234 indicates, as the position on the indicator 232, the value of the resource usage state in the “S” rank at the present time or a specified time or period of time. The group display section 236 indicates the displayed group. The problem display section 238 indicates the presence or absence, or the degree of problem of the resource usage state in the “S” rank. The numerical value display section 240 indicates, as a numerical value, the value of the resource usage state in the “S” rank at the present time or a specified time or period of time. The increase or decrease display section 242 indicates the increase or decrease state of the resource usage state in the “S” rank in the specified period.

As illustrated in FIG. 9(b), the image 250 includes, for example, an indicator 252, a state icon 254, a group display section 256, a problem display section 258, a numerical value display section 260, an increase or decrease display section 262, and an arrow icon 264. The indicator 252 represents an index based on the reference value of the resource usage state in the “C” rank. The state icon 254 indicates, as the position on the indicator 252, the value of the resource usage state in the “C” rank at the present time or a specified time or period of time. The group display section 256 indicates the displayed group. The problem display section 258 indicates the presence or absence, or the degree of problem of the resource usage state in the “C” rank. The numerical value display section 260 indicates, as a numerical value, the value of the resource usage state in the “C” rank at the present time or a specified time or period of time. The increase or decrease display section 262 indicates the increase or decrease state of the resource usage state in the “C” rank in the specified period. The arrow icon 264 indicates that the resource usage state in the “C” rank in the specified period decreases to be out of the tolerance range.

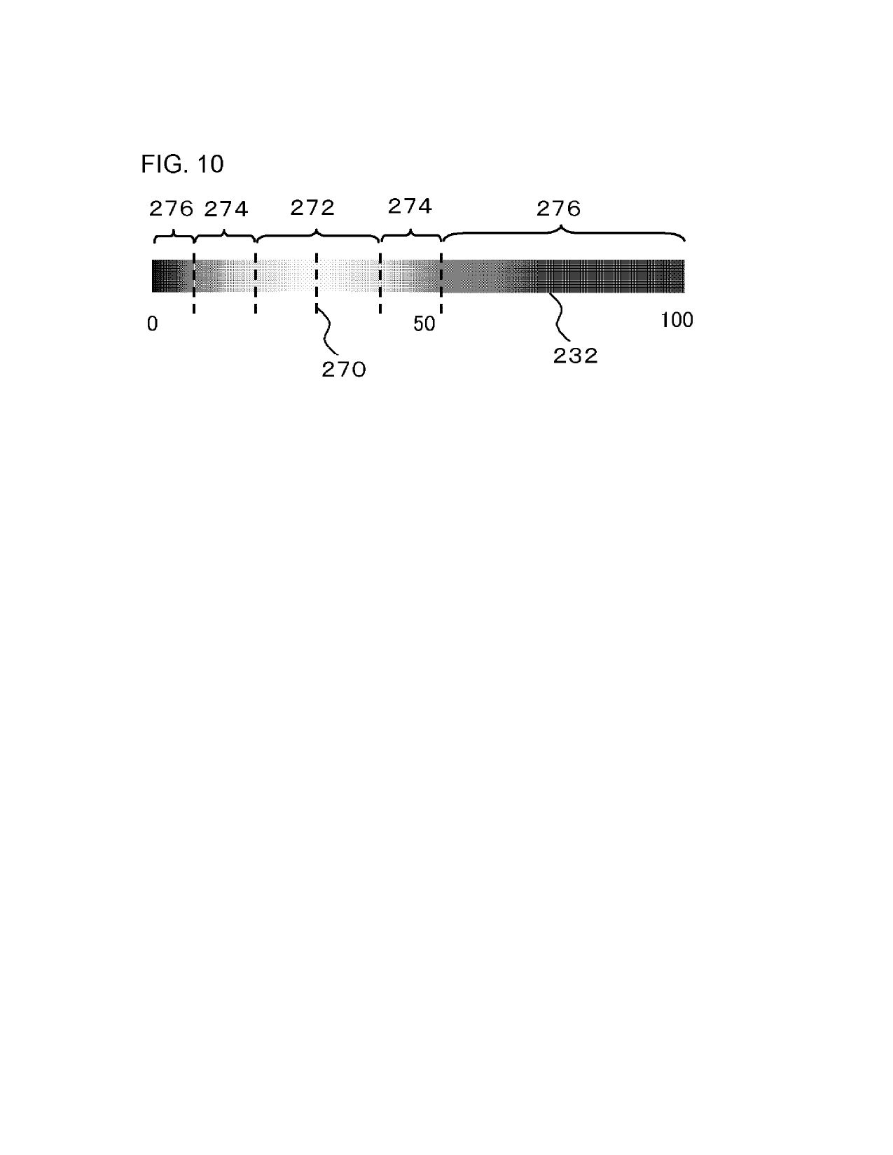

As illustrated in FIG. 9, the indicator 232 and the indicator 252 show indicators in different colors so that the tolerance range can be understood at a glance in a visual manner based on the reference value of the resource usage state for each group. As illustrated in FIG. 10, for example, the indicator 232 in the “S” rank includes a first region 272, a second region 274, and a third region 276. The first region 272 has a center 270 which is the reference value in the “S” rank, and the tolerance range is shown at both sides of the center 270. The second region 274 is a range at a position further away from the center 270 toward the outside of the first region 272, and is a region at the border between the range where the resource usage state causes a problem (third region 276) and the tolerance range (first region 272). The third region 276 indicates a range where the resource usage state beyond the tolerance range of the reference value of the “S” rank causes a problem.

The range of each region may be specified in advance, or may be specified for each group, or may be common to all the groups. The range of each region may be specified with a numerical value within the indicator, or a ratio of each region may be specified with the reference value being the center.

In the present exemplary embodiment, for example, the first region 272 may be in green or blue so that it is possible to recognize at a glance that there is no problem in the resource usage state. The second region 274 may be in yellow so that it is possible to recognize at a glance that a problem is being caused in the resource usage state. The third region 276 may be in red so that it is possible to recognize at a glance that there is a problem in the resource usage state. As illustrated in FIG. 10, the indicator 232 may be in different colors with gradation of the above colors.

Back to FIG. 9, each of the problem display section 238 and the problem display section 258 is an icon representing the presence or absence, or the degree of problem of the resource usage state for each group. In FIG. 9(a), as the position of the state icon 234 indicates, the resource usage state in the “S” rank has a value satisfying the reference value, and therefore, the problem display section 238 may be, for example, an icon in blue or green so that it is possible to find at a glance that there is no problem. On the other hand, in FIG. 9(b), as the position of the state icon 254 indicates, the resource usage state in the “C” rank has a value out of the tolerance range of the reference value, and therefore, the problem display section 258 may be, for example, an icon in red so that it is possible to find at a glance that there is a problem.

It should be noted that the problem display section is not limited thereto. As long as it is an image expression showing the presence or absence, or the degree of problem in an easy-to-understand manner, any expression may be employed. For example, when there is a problem, the problem display section may be blinked, or an icon including characters or patterns (OK, NG, and the like) indicating the presence or absence of problem.

Operation of the display processing system 1 according to the present exemplary embodiment configured as described above will be explained below.

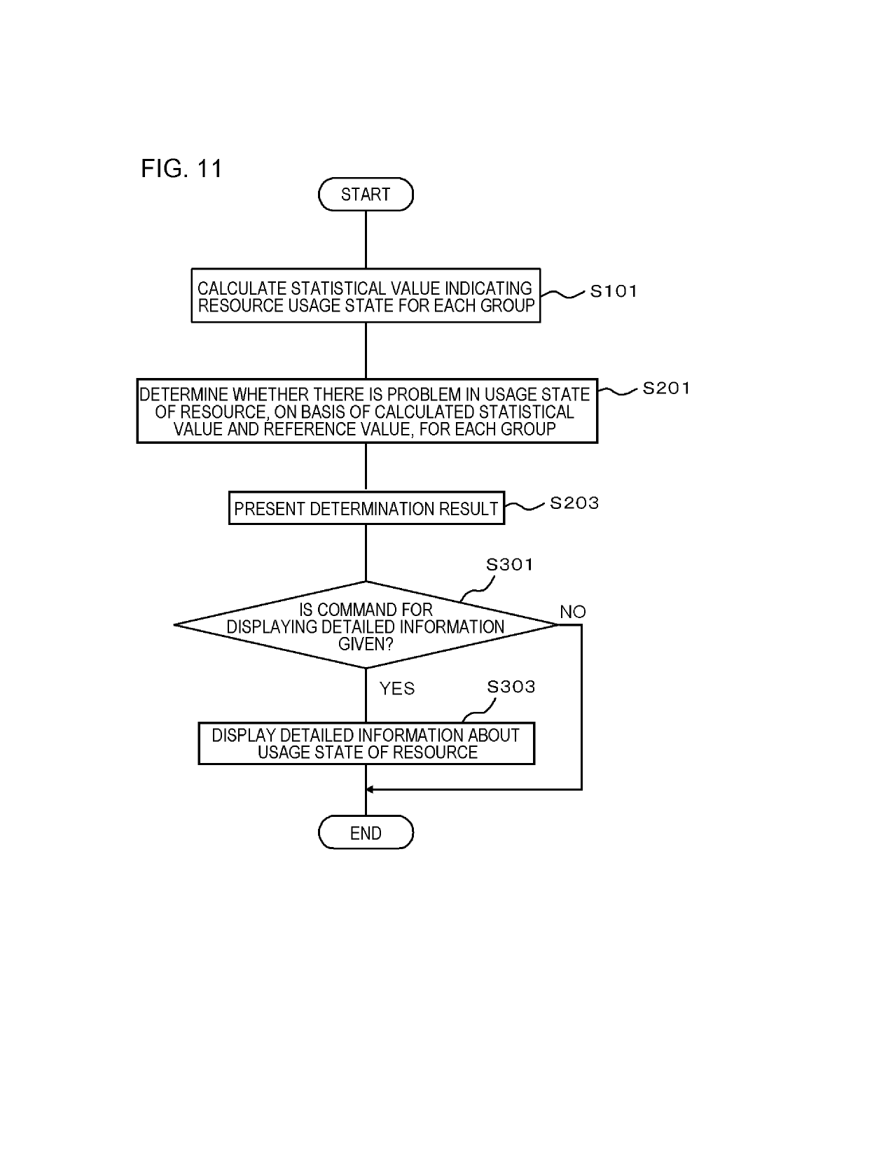

FIG. 11 is a flowchart illustrating an example of operation of the display processing system 1 according to the present exemplary embodiment. Hereinafter, explanation will be made with reference to FIGS. 7 to 11.

It should be noted that the flowchart of FIG. 11 includes step S101, step S201, and step S203 which are the similar to those in the flowchart of FIG. 6, and in addition, the flowchart of FIG. 11 includes step S301 and step S303.

Suppose that while the state display unit 204 (FIG. 7) of the display processing apparatus 300 displays the screen 130 of FIG. 8 on the display device 30 (FIG. 1) (step S203), the administrator moves the mouse pointer 140 to the resource usage efficiency field 134 (FIG. 8) of the screen 130, and clicks the icon of the group of which details the administrator wants to see. When the icon is clicked as a command for displaying detailed information (YES in step S301), the reception unit 302 (FIG. 7) of the display processing apparatus 300 receives the group selected as the command for displaying the detailed information.

Then, the detailed display unit 304 (FIG. 7) of the display processing apparatus 300 displays, for example, the image 230 of FIG. 9(a) as the detailed information about the group received by the reception unit 302 (step S303).

As explained above, according to the display processing system 1 according to the present exemplary embodiment, the effects similar to those of the above exemplary embodiment are achieved, and the resource usage state can be understood in an intuitive manner. This is because the detailed display of the usage state of the resource can be presented for each group, and the detailed display schematically shows the relationship between the current statistical value and the reference value of the resource usage state of the group. Therefore, when a problem is expected, measures can be quickly taken to solve the problem, and as a result, the efficiency and reliability of the system management are improved.

For example, a group having a CPU utilization in a red region at the right side of the green region in the indicator 232 indicates a higher CPU utilization than the reference value, and therefore, the load of the server is considered to be too high. Therefore, the administrator receives the result, and can take measures to satisfy the reference of the group, for example, changing and increasing the allocation of the resource of the group, additionally installing the servers, and replacing the servers with those with higher performance. When the load of the server is high, this may cause system failure, and measures can be taken quickly by presenting whether there is a problem in the usage state of the resource as described above, and therefore, the reliability of the system is improved.

For example, a group having a CPU utilization in a red region at the left side of the green region in the indicator 232 indicates a lower CPU utilization than the reference value, and therefore, the resource is considered to be wasted. Therefore, the administrator receives the result, and reduces the power consumption by changing and reducing the allocation of the resource of the group and stopping the use of a non-operating server by turning off the server, or can take measures to satisfy the reference of the group, for example, making a plan to further increase the contracts of that group.

### Fourth Exemplary Embodiment

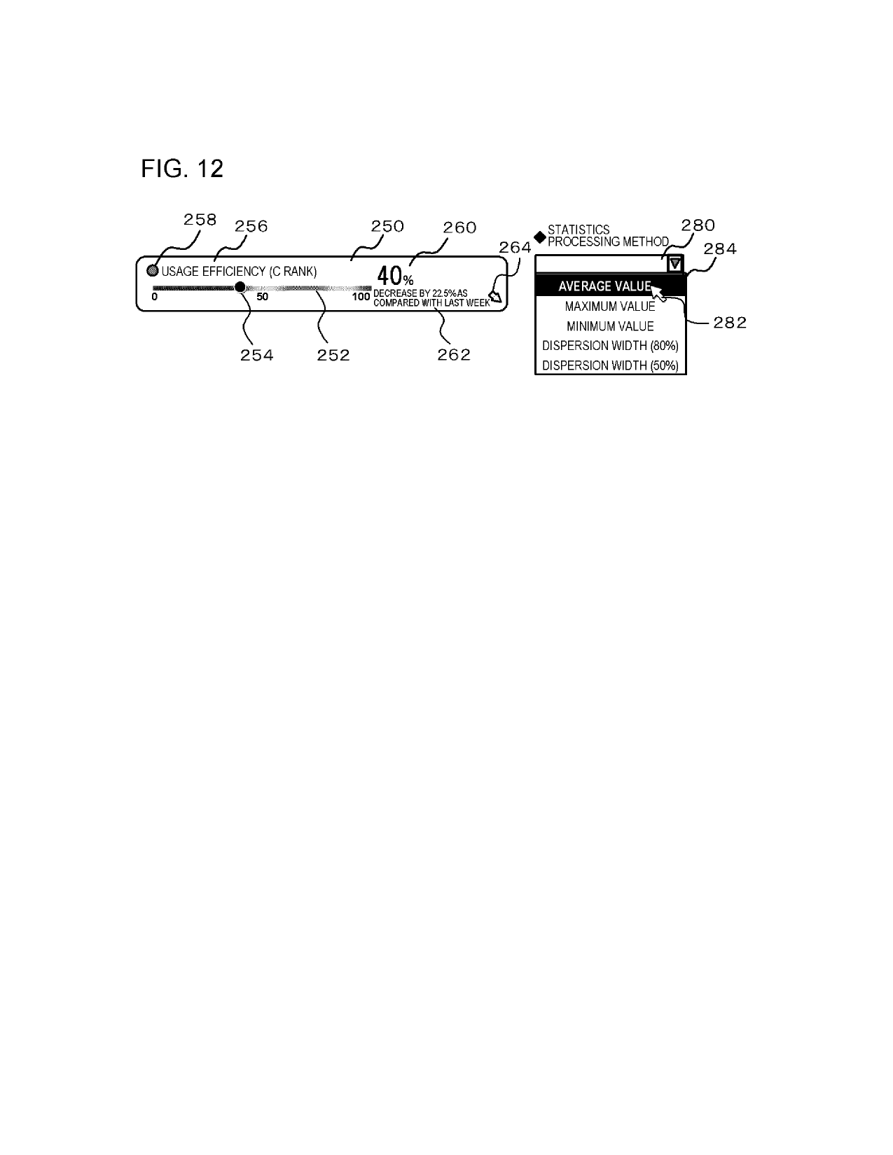

FIGS. 12 to 14 are figures illustrating examples of images illustrating resource usage states displayed by a display processing apparatus achieved by a computer of a display processing system 1 according to the exemplary embodiment of the present invention. The display processing system 1 according to the present exemplary embodiment is different from the above exemplary embodiment in that the display processing system 1 according to the present exemplary embodiment can present detailed information about the usage state of the resource for each group, upon selecting information from among the values on which various kinds of statistics processing are performed.

More specifically, the display processing system 1 according to the present exemplary embodiment has the configuration similar to the display processing apparatus 300 of FIG. 7. Hereinafter, explanation will be made with reference to FIGS. 7 and 12 to 14.

In the display processing apparatus 300 according to the present exemplary embodiment, when the reception unit 302 receives a group, the detailed display unit 304 displays the image 250 as illustrated in FIG. 12 on the display device 30.

In the present exemplary embodiment, a statistics method selection list 280 is further provided. The statistics method selection list 280 selects a statistics processing method of statistical values indicating the resource usage state displayed on the image 250. The statistics method selection list 280 may be displayed, for example, as a menu list in a window displaying the image 250. Further, the reception unit 302 receives the statistics processing method selected by the statistics method selection list 280, and notifies it to the calculation unit 102 or the state display unit 204.

The calculation unit 102 may calculate the statistical values using the selected statistics processing method when the notification is received from the reception unit 302, or the statistical values may be calculated by all the statistics processing methods in advance, and may be stored to the memory 14 (FIG. 1) of the display processing apparatus 100.

When the state display unit 204 receives a notification from the reception unit 302, the state display unit 204 displays, on the display device 30, the statistical values calculated according to the selected statistics processing method.

In the present exemplary embodiment, the statistics method selection list 280 includes statistics processing methods such as an average value, a maximum value, a minimum value, a dispersion width (80%), and a dispersion width (50%). The administrator uses the input device 40 to move the mouse pointer 282 and may make selection from the statistics method selection list 280, and the selected statistics processing method is made into a reversed display 284.

When the average value is selected in the statistics method selection list 280, the state display unit 204 displays, on the display device 30, the average value of the resource usage state in the “C” rank for a predetermined period, for example, one week, as the state icon 254 on the image 250 as illustrated in FIG. 12. When the maximum value and the minimum value are selected in the statistics method selection list 280, the state display unit 204 displays, on the display device 30, the maximum value or the minimum value of the statistical values in the predetermined period as the state icon 254 on the image 250. When the maximum value and the minimum value are displayed in this manner, abnormality of the number of resources that does not affect the average value can be found.

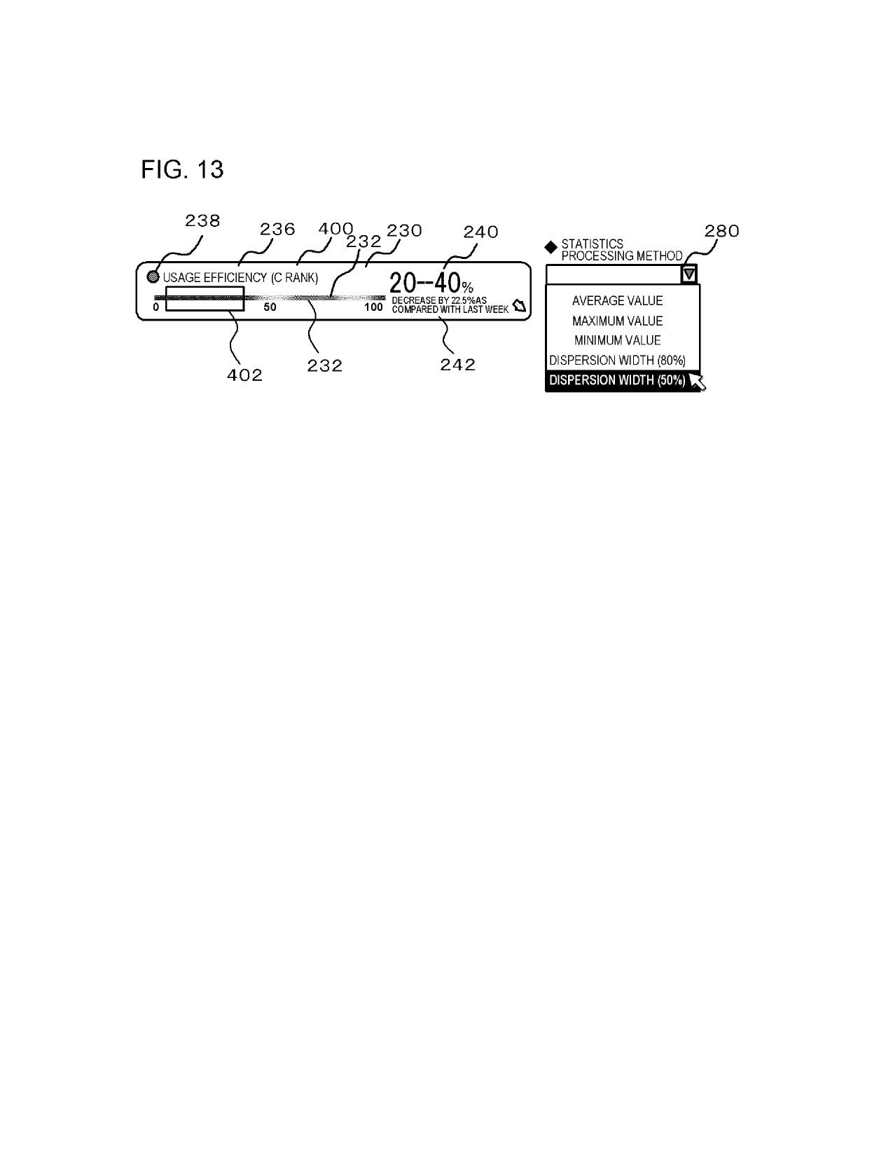

FIG. 13 illustrates an example of an image 400 where the dispersion width (50%) is selected from the statistics method selection list 280. The state display unit 204 presents a region where the dispersion width of the statistical values is in the range of 50% as overlaid on the indicator 232 in a dispersion width display frame 402.

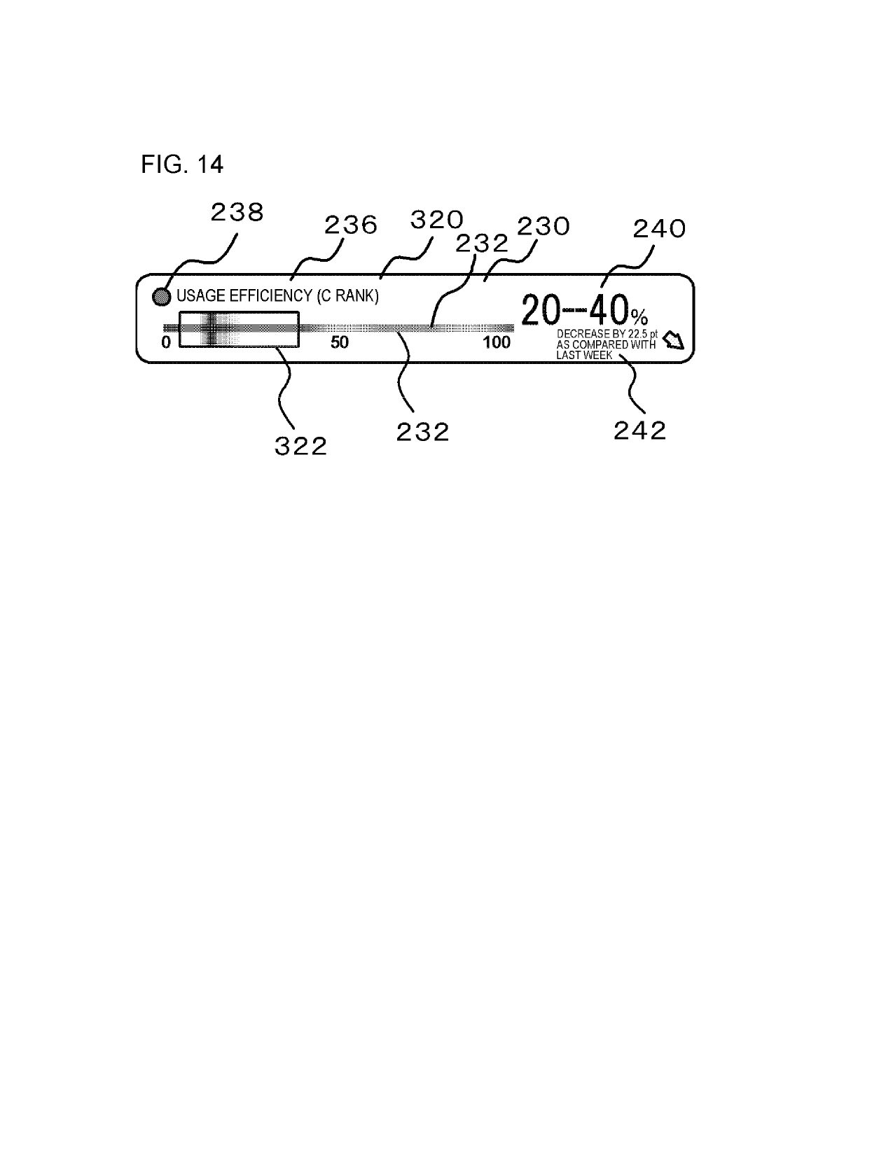

Another example is an image 320 as illustrated in FIG. 14, in which a range where the dispersion width of the same statistical value is within a range of 50% is presented with a dispersion width display unit 322. This dispersion width display unit 322 shows the region where the dispersion width of the statistical values is within a range of 50%, and shows the dispersion state with gradation. The dispersion width display unit 322 of FIG. 14 indicates that the center of the dispersion is slightly deviated to the left side. As described above, when the dispersion value is shown, it may be possible to let the administrator notice a problem that could not be noticed with the average value when the value indicated by the average value is different from the center of the dispersion.

As explained above, according to the display processing system 1 according to the present exemplary embodiment, the effects similar to those of the above exemplary embodiment are achieved, and the usage state of the resource can be considered from various aspects for each group. This is because the detailed display of the usage state of the resource can be presented for each group, and the detailed display can be displayed upon appropriately making selection from among the values calculated according to various kinds of statistics processing methods. Therefore, the problem can analyzed based on appropriate information, and when a problem is expected, appropriate measures can be quickly taken to solve the problem, and as a result, the efficiency and reliability of the system management are improved.

The exemplary embodiments of the present invention have been hereinabove explained with reference to drawings. However, they are merely examples of the present invention, and various configurations other than the above can also be employed.

For example, a notification unit (not shown) may be additionally provided. The notification unit (not shown) displays, on the display device 30, a message for notifying the administrator of what kind of problem is expected when the presence or absence of problem is presented. The message may be as follows. For example, when the CPU utilization is higher than the reference value of a certain group, the message may notify that “the load of the server may be too high”, or when the CPU utilization is lower than the reference value of a certain group, the message may notify that “the resource is considered to be wasted”.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2010-197777 filed on Sep. 3, 2010, the disclosure of which is incorporated herein in its entirety by reference.

1. A display processing system comprising a state display unit which presents a usage state of a resource with respect to a reference value for each group based on a statistical value indicating said usage state of said resource,
wherein said reference value is that of a value indicating the usage state of the resource of a system providing a service, and is provided for said each group classified in accordance with policy.

2. The display processing system according to claim 1 further comprising:
a determination unit which determines whether there is a problem in said usage state of said resource based on said statistical value and said reference value for each group; and
a presentation unit which presents a determination result made by said determination unit.

3. The display processing system according to claim 1 further comprising a calculation unit which calculates a statistical value indicating said usage state of said resource in accordance with at least one statistics processing method for each group.

4. The display processing system according to claim 3 further comprising a reception unit which receives at least one selection from among a plurality of statistics processing methods,
wherein said state display unit presents said usage state of said resource based on said statistical value calculated in accordance with said statistics processing method received by said reception unit.

5. The display processing system according to claim 3 further comprising a collection unit which collects a value indicating the usage state of said resource associated with said group,
wherein said calculation unit uses said value collected by said collection unit to calculate said statistical value for each group.

6. The display processing system according to claim 1, wherein said state display unit presents said usage state of said resource by displaying said statistical value on an indication scale indicating an index based on said reference value.

7. A display processing method comprising presenting, by a proceeding apparatus having a display unit, a usage state of a resource with respect to a reference value for each group based on a statistical value indicating said usage state of said resource,
wherein said reference value is that of a value indicating the usage state of the resource of a system providing a service, and is provided for said each group classified in accordance with policy.

8. A program for causing a computer having a display unit to perform a procedure for presenting a usage state of a resource with respect to a reference value for each group based on a statistical value indicating said usage state of said resource,
wherein said reference value is that of a value indicating the usage state of the resource of a system providing a service, and is provided for said each group classified in accordance with policy.

9. A display processing system comprising means for presenting a usage state of a resource with respect to a reference value for each group based on a statistical value indicating said usage state of said resource,
wherein said reference value is that of a value indicating the usage state of the resource of a system providing a service, and is provided for said each group classified in accordance with policy.
